(19) United States
(12) Patent Application Publication
(10) Pub. No.: US 2019/0275760 A1
(43) Pub. Date: Sep. 12, 2019

(54) WET FRICTION MATERIAL WITH ORIFICES

(71) Applicant: Schaeffler Technologies AG & Co. KG, Herzogenaurach (DE)

(72) Inventors: Rashid FARAHATI, Copley, OH (US); Olusanmi ADENIRAN, Wooster, OH (US)

(21) Appl. No.: 15/913,196

(22) Filed: Mar. 6, 2018

(51) Int. Cl. B32B 3/26; B32B 5/26; B32B 7/12; B32B 37/12; B32B 38/00; F16D 13/64

(52) U.S. Cl. CPC B32B 3/266; B32B 5/26; B32B 7/12; B32B 37/12; B32B 38/00; F16H 2045/0294; B32B 2605/00; B32B 2315/16; F16D 2250/0038; F16D 2200/006; F16D 13/64

(57) ABSTRACT

A method of making a wet friction material includes providing an outer layer on a base layer to form the wet friction material. The base layer includes a proportion of first fiber material and a proportion of first filler material and the outer layer includes a proportion of second fiber material and a proportion of second filler material. The proportion of second fiber material is less than the proportion of first fiber material and the proportion of second filler material is greater than the proportion of first filler material. The method also includes forming a plurality of orifices passing through the outer layer.

The present disclosure relates generally to friction clutches and plates used in torque converters and motor vehicle transmissions and more specifically to wet friction material.

### BACKGROUND

The friction material in wet-type friction clutches generally operates in an oil submerged environment and is often paper-based material used to form friction material rings. It is known to spray or sprinkle diatomaceous earth sold under the trade name CELITE on top of the base materials directly during the paper making process in a Fourdrinier machine at the wet end of the machine when the paper base material is being moved along a conveyor. This process is good for very high volume papers, but there is large waste during initial set up, so it is not practical for smaller volume production.

U.S. Pat. No. 6,013,696 discloses using a laser to form pores in a cured, resin-impregnated friction material.

U.S. Pat. No. 6,318,534 discloses friction material having micro-pockets formed on the surface.

U.S. Pub. 2017/0089415 discloses friction material including a bottom layer and a top layer forming a paper composite, with pores being created by a laser in the top surface.

U.S. Pub. 2017/0261057, U.S. Pub. 2006/0008635, U.S. Pub. 2017/0335913 and U.S. Pat. No. 9,499,759 disclose friction material including two or more layers.

### SUMMARY OF THE INVENTION

A method of making a wet friction material is provided. The method includes providing an outer layer on a base layer to form the wet friction material. The base layer includes a proportion of first fiber material and a proportion of first filler material and the outer layer includes a proportion of second fiber material and a proportion of second filler material. The proportion of second fiber material is less than the proportion of first fiber material and the proportion of second filler material is greater than the proportion of first filler material. The method also includes forming a plurality of orifices passing through the outer layer.

According to embodiments of the method, the base layer has a first thickness, the outer layer has a second thickness, the wet friction material may have a total thickness equaling the first thickness plus the second thickness and the second thickness may be 10% to 30% of the total thickness. The orifices may have a maximum diameter of 50 μm to 200 μm. The orifices may represent 10% to 30% of a total surface area of an outer surface of the outer layer. The first filler material and the second filler material may be each formed by one or more fillers from a group consisting of diatomaceous earth and/or clay. The first fiber material and the second fiber material may be each formed by one or more fibers from a group consisting of aramid fibers, organic fibers and/or carbon fibers. The proportion of first fiber material may be between 35 to 60% of the base layer and the proportion of second fiber material may between of 5 to 25% of the outer layer. The proportion of first filler material may be between 15 to 50% by percentage weight of the base layer and the proportion of second filler may be between of 45 to 75% by percentage weight of the outer layer. The providing of the outer layer on the base layer to form the wet friction material may include laminating the outer layer on the base layer. At least one of the base layer and the outer layer may include a binder. The laminating of the outer layer on the base layer may include applying heat and pressure to the outer layer to fix the outer layer and the base layer together via the binder.

A clutch assembly is also provided including a metal part and the wet friction material fixed on the metal part.

A wet friction material is also provided. The wet friction material includes a base layer; and an outer layer on the base layer. The base layer includes a proportion of first fiber material and a proportion of first filler material and the outer layer includes a proportion of second fiber material and a proportion of second filler material. The proportion of second fiber material is less than the proportion of first fiber material and the proportion of second filler material is greater than the proportion of first filler material. The outer layer includes a plurality of orifices passing through the outer layer.

According to embodiments of the wet friction material, the base layer has a first thickness, the outer layer has a second thickness, the wet friction material may have a total thickness equaling the first thickness plus the second thickness and the second thickness may be 10% to 30% of the total thickness. The orifices may have a maximum diameter of 50 μm to 200 μm. The orifices may represent 10% to 30% of a total surface area of an outer surface of the outer layer. The first filler material and the second filler material may be each formed by one or more fillers from a group consisting of diatomaceous earth and/or clay. The first fiber material and the second fiber material may be each formed by one or more fibers from a group consisting of aramid fibers, organic fibers and/or carbon fibers. The proportion of first fiber material may be between 50 to 80% of the base layer and the proportion of second fiber material may be between of 5 to 30% of the outer layer. The proportion of first filler material may be between 15 to 50% by percentage weight of the base layer and the proportion of second filler may be between of 45 to 75% by percentage weight of the outer layer.

### BRIEF DESCRIPTION OF THE DRAWINGS

The present disclosure is described below by reference to the following drawings, in which:

FIG. 1 shows a base layer and an outer layer for forming the wet friction material in accordance with one embodiment of the present disclosure;

FIG. 2 shows the outer layer being laminated to the base layer;

FIG. 3 shows a laser forming orifices in the outer layer;

FIG. 4 shows the wet friction material, with orifices in the outer layer, being fixed to a metal part;

FIG. 5 shows a lockup clutch assembly of a torque converter including the wet friction material with orifices in the outer layer; and

FIG. 6 shows a top plan view of an exemplary embodiment of the outer surface of the friction material.

### DETAILED DESCRIPTION

The present disclosure provides embodiments of wet friction material that are able to provide a sufficient friction at high slip speed while also maintaining porosity. Adding a friction modifier layer to the top surface improves the friction performance, but clogs the pores of the underlying wet friction material. The present disclosure provides small orifices in the friction modifier layer increase the porosity and the performance in high slip speed.

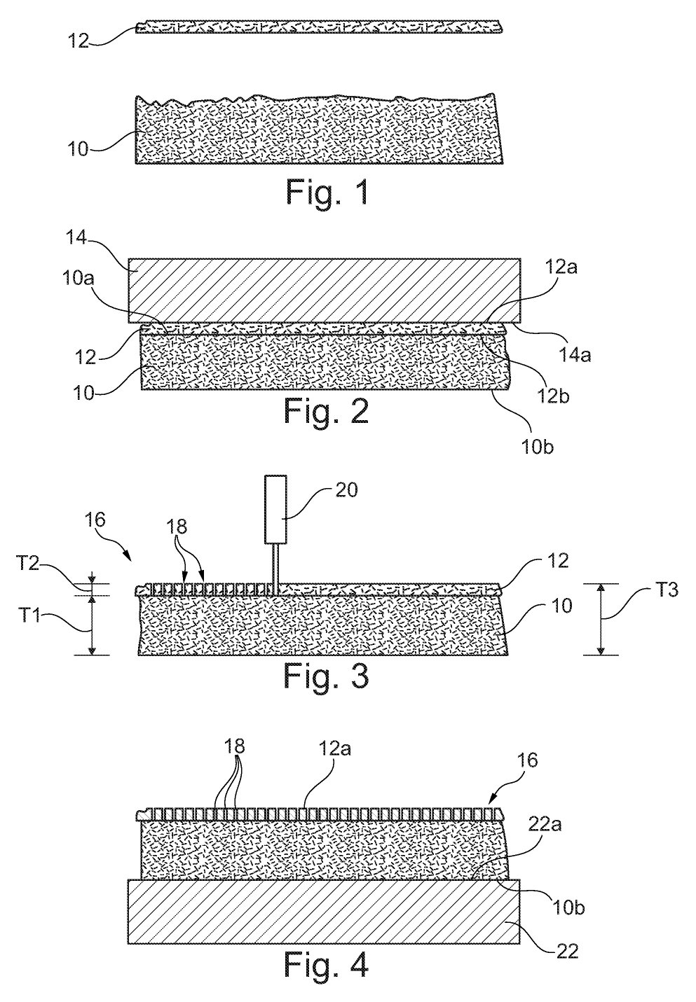

FIGS. 1 to 4 schematically illustrate a method of forming a wet friction material and a clutch assembly in accordance with an embodiment of the present disclosure. A base wet friction material layer 10 is manufactured separately from or as a single piece with an outer layer 12. FIG. 1 shows base layer 10 and outer layer 12 as separate pieces.

Base layer 10 is a wet friction material formed of fibers, filler material and a binder. The fibers can be aramid fibers, organic fibers, carbon fibers and/or fiberglass. The organics fibers include cellulose fibers or cotton fibers. The fillers can be diatomaceous earth and/or clay. The binder can be a phenolic resin, a latex or a silane. Optionally a friction modifier such as graphite may also be included in base layer 10.

Outer layer 12 includes fibers, filler material and a binder. The fibers can be aramid fibers, organic fibers, carbon fibers and/or fiberglass. The organic fibers include cellulose fibers or cotton fibers. The fillers can be diatomaceous earth and/or clay. The binder can be a phenolic resin, a latex or a silane. Optionally a friction modifier such as graphite may also be included in outer layer 12. The composition of outer layer 12 includes a higher ratio of filler material and a lower ratio of fibers than base layer 10, such that outer layer 12 is less porous and more dense than base layer 10, has a higher coefficient of friction than base layer 10 and a higher wear resistance than base layer 10. The fibers of layers 10 and 12 have a mean diameter of 45 to 55 microns and a mean length of 1 to 2 millimeters.

In one preferred embodiment, base layer 10 includes, by percentage weight, 35 to 60% fibers, 15 to 40% filler material and 20 to 30% binder. In another preferred embodiment, base layer 10, by percentage weight, 35 to 55% fibers, 15 to 40% filler material and 20 to 30% binder. More specifically, in one preferred embodiment, base layer 10 includes, by percentage weight, 30 to 55% aramid and organic fibers and 5 to 10% carbon fibers, 15 to 40% filler material and 20 to 30% binder. In another preferred embodiment, base layer 10 includes, by percentage weight, 40 to 60% aramid and organic fibers and 5 to 10% carbon fibers, 15 to 40% filler material and 20 to 30% binder.

In one preferred embodiment, outer layer 12 includes, by percentage weight, 5 to 25% fibers, 45 to 75% filler material and 20 to 30% binder.

FIG. 2 shows the two separate layers 10, 12 being joined together via lamination. The lamination includes pressing outer layer 12 against base layer 10 with a heat plate 14 to cure the binder in at least one of layers 10, 12, fixing outer layer 12 and base layer 10 together. The binder is provided into the pores of a matrix formed by the fibers and the filler material of layers 10, 12. The force of pressing of heat plate 14 against an outer surface 12a of outer layer 12, while a lower surface 12b of outer layer 12 rests on a support surface, causes the binder to accumulate at an interface of an inner surface 12b of outer layer 12 and an outer surface 10a of base layer 10, while the curing of the binder by the heat of heat plate 14 creates a permanent connection between base layer 10 and outer layer 12. In one preferred embodiment, the heat at a surface 14a of plate 14 that contacts outer surface 12a of outer layer is 375 to 425 degrees F.

FIG. 3 shows a wet friction material 16 formed by the joining of base layer 10 and outer layer 12 as described with respect to FIG. 2. Wet friction material 16 is formed such that outer layer 12 has a thickness T1 between outer surface 12a and inner surface 12b, base layer 14 has a thickness T2 between outer surface 10a and lower surface 10b, and wet friction material 16 has a total thickness T3 between outer surface 10a and lower surface 10b. In one preferred embodiment, the thickness T2 of outer layer 12 is equal 10 to 30% of the total thickness T3, with thickness T1 of base layer 10 thus being 70 to 90% of the total thickness T3.

After the forming of wet friction material 16, a plurality of orifices 18 are formed in outer layer 12 by a laser 20. Orifices 18 extend from outer surface 12a to inner surface 12b such that orifices 18 extend through outer layer 12 to undercover the porous matrix of base layer 10. Orifices 18 thus allow fluid at outer surface 12a of outer layer 12 to access the porous matrix of base layer 10. Laser 20 is moved in a controlled manner over surface 12a of outer layer 12 and repetitively pulsed to form orifices 18. In one preferred embodiment, orifices 18 are formed in outer layer 12 each have a maximum diameter of 50 μm to 200 μm and represent 10% to 30% of the total surface area of outer surface 12a of outer layer. Maximum diameter is defined as the greatest distance between two edge points of an orifice as measured from outer surface 12a. Total surface area means the surface area of outer surface 12a before orifices 18 are added, i.e., the surface area of outer surface 12a after orifices 18 are added, plus the surface area removed by the formation of orifices 18.

FIG. 4 shows wet friction material 16 bonded to a metal part 22. More specifically, adhesive is applied to lower surface 10b of base layer 10 or to a surface 22a of metal part 22 and wet friction material 16 is bonded to metal part 22 with surface 12a and orifices 18 facing away from metal part 22.

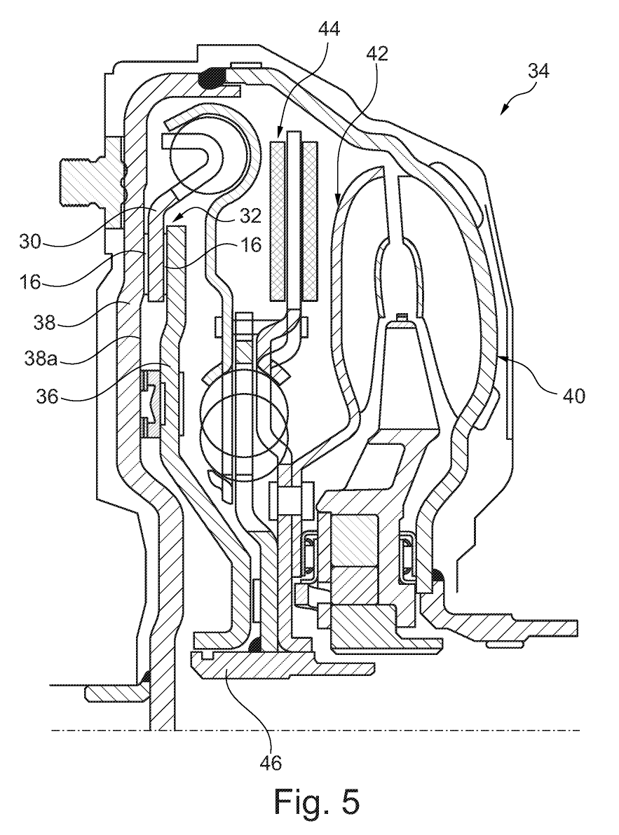

FIG. 5 shows wet friction material 16 bonded to both sides of a metal part in the form of a clutch plate 30 of lockup clutch assembly 32 of a torque converter 34. A piston 36 of lockup clutch assembly 32 forces clutch plate 30 against an inside surface 38a of a front cover 38 of torque converter 34. Piston 36 contacts the surface 12a provided with orifices 18 (FIG. 4) of the rear piece of wet friction material 16 to force the surface 12a provided with orifices 18 on the front piece of wet friction material 16 against inside surface 38a of front cover 38. The forcing of clutch plate 30 against front cover 38 by piston 36 locks the lockup clutch assembly 32 such that a torque path in torque converter 34 to a transmission input shaft bypasses an impeller 40 and a turbine 42 of torque converter 34, and instead flows from front cover 38 to clutch plate 30 and through a damper assembly 44 to a transmission input shaft that is connected to an output hub 46 of torque converter 34.

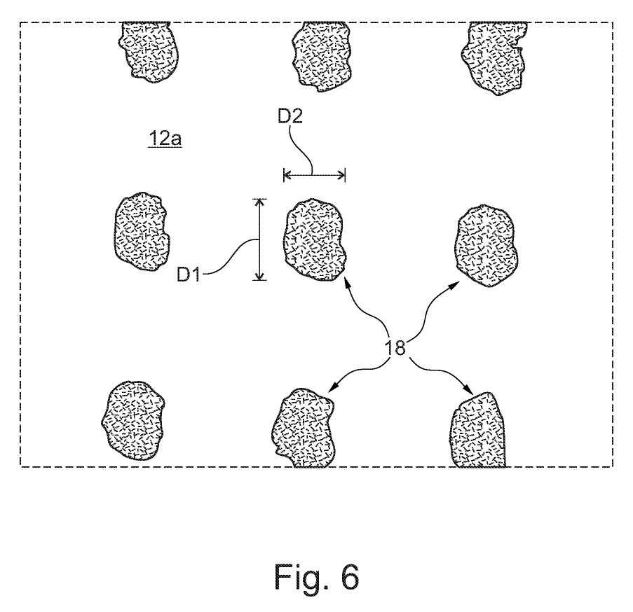

FIG. 6 shows a top plan view of an exemplary embodiment of outer surface 12a. Outer surface 12a includes a plurality of orifices 18 spaced apart from each other. Orifices 18 are each elliptically shaped and have a maximum diameter D1 and a minimum diameter D2 at outer surface 12a.

In the preceding specification, the disclosure has been described with reference to specific exemplary embodiments and examples thereof. It will, however, be evident that various modifications and changes may be made thereto without departing from the broader spirit and scope of disclosure as set forth in the claims that follow. The specification and drawings are accordingly to be regarded in an illustrative manner rather than a restrictive sense.

### LIST OF REFERENCE NUMERALS

10 base layer
10a outer surface
10b lower surface
12 outer layer
12a outer surface
12b inner surface
14 heat plate
14a plate surface
16 wet friction material
18 orifices
20 laser
22 metal part
22a surface
30 clutch plate
32 lockup clutch assembly
34 torque converter
36 piston
38 front cover
38a inside surface
40 impeller
42 turbine
44 damper assembly
46 output hub

What is claimed is:

1. A method of making a wet friction material comprising:
providing an outer layer on a base layer to form the wet friction material, the base layer including a proportion of first fiber material and a proportion of first filler material, the outer layer including a proportion of second fiber material and a proportion of second filler material, the proportion of second fiber material being less than the proportion of first fiber material, the proportion of second filler material being greater than the proportion of first filler material; and
forming a plurality of orifices passing through the outer layer.

2. The method as recited in claim 1 wherein the base layer has a first thickness and the outer layer has a second thickness, the wet friction material having a total thickness equaling the first thickness plus the second thickness, the second thickness being 10% to 30% of the total thickness.

3. The method as recited in claim 1 wherein the orifices each have a maximum diameter of 50 μm to 200 μm.

4. The method as recited in claim 1 wherein the orifices represent 10% to 30% of a total surface area of an outer surface of the outer layer.

5. The method as recited in claim 1 wherein the first filler material and the second filler material are each formed by one or more fillers from a group consisting of diatomaceous earth and/or clay.

6. The method as recited in claim 1 wherein the first fiber material and the second fiber material are each formed by one or more fibers from a group consisting of aramid fibers, organic fibers and/or carbon fibers.

7. The method as recited in claim 1 wherein the proportion of first fiber material is between 35 to 60% by percentage weight of the base layer and the proportion of second fiber material is between of 5 to 25% by percentage weight of the outer layer.

8. The method as recited in claim 7 wherein the proportion of first filler material is between 15 to 50% by percentage weight of the base layer and the proportion of second filler material is between of 45 to 75% by percentage weight of the outer layer.

9. The method as recited in claim 1 wherein the providing of the outer layer on the base layer to form the wet friction material includes laminating the outer layer on the base layer.

10. The method as recited in claim 9 wherein at least one of the base layer and the outer layer includes a binder and the laminating of the outer layer on the base layer includes applying heat and pressure to the outer layer to fix the outer layer and the base layer together via the binder.

11. A method of making a part of a friction clutch comprising:
making the wet friction material with the method as recited in claim 1; and
fixing the wet friction material to a metal part.

12. A wet friction material comprising:
a base layer; and
an outer layer on the base layer, the base layer including a proportion of first fiber material and a proportion of first filler material, the outer layer including a proportion of second fiber material and a proportion of second filler material, the proportion of second fiber material being less than the proportion of first fiber material, the proportion of second filler material being greater than the proportion of first filler material, the outer layer including a plurality of orifices passing through the outer layer.

13. The wet friction material as recited in claim 12 wherein the base layer has a first thickness and the outer layer has a second thickness, the wet friction material having a total thickness equaling the first thickness plus the second thickness, the second thickness being 10% to 30% of the total thickness.

14. The wet friction material as recited in claim 12 wherein the orifices have a maximum diameter of 50 μm to 200 μm.

15. The wet friction material as recited in claim 12 wherein the orifices represent 10% to 30% of a total surface area of an outer surface of the outer layer.

16. The wet friction material as recited in claim 12 wherein the first filler material and the second filler material are each formed by one or more fillers from a group consisting of diatomaceous earth and/or clay.

17. The wet friction material as recited in claim 12 wherein the first fiber material and the second fiber material are each formed by one or more fibers from a group consisting of aramid fibers, organic fibers and/or carbon fibers.

18. The wet friction material as recited in claim 12 wherein the proportion of first fiber material is between 35 to 60% by percentage weight of the base layer and proportion of second fiber material is between of 5 to 25% by percentage weight of the outer layer.

19. The wet friction material as recited in claim 18 wherein the proportion of first filler material is between 15 to 50% by percentage weight of the base layer and the proportion of second filler material is between of 45 to 75% by percentage weight of the outer layer.

20. A clutch assembly comprising:
a metal part; and
the wet friction material as recited in claim 12 fixed on the metal part.
